(19) United States
(12) Patent Application Publication
(10) Pub. No.: US 2014/0363282 A1
(43) Pub. Date: Dec. 11, 2014

(54) TURBINE HOUSING AND TURBOCHARGER

(71) Applicant: IHI Corporation, Koto-ku (JP)

(72) Inventor: Takehiko KATOU, Tokyo (JP)

(73) Assignee: IHI Corporation, Koto-ku (JP)

(21) Appl. No.: 14/468,381

(22) Filed: Aug. 26, 2014

Related U.S. Application Data
(63) Continuation of application No. PCT/JP2013/056104, filed on Mar. 6, 2013.

(30) Foreign Application Priority Data
Mar. 9, 2012 (JP) 2012-053306

(51) Int. Cl. F02B 47/08; F04D 29/42

(52) U.S. Cl. CPC F02B 47/08; F04D 29/4206
USPC 415/204

(57) ABSTRACT

A turbine housing includes a scroll passage provided with a housing tongue. A groove portion (a notch) is formed in a wall surface on the scroll passage side of the housing tongue. The groove portion is located at a position close to an edge portion on the flange side of the wall surface. The groove portion extends from a tip end side of the housing tongue in an extending direction of the scroll passage. In a cross section orthogonal to the extending direction of the scroll passage, a curvature radius of the deepest part of the groove portion is smaller than a minimum curvature radius of the wall surface of the housing tongue.

### CROSS REFERENCE TO RELATED APPLICATIONS

This application is a continuation application of International Application No. PCT/JP2013/056104, filed on Mar. 6, 2013, which claims priority to Japanese Patent Application No. 2012-053306, filed on Mar. 9, 2012, the entire contents of which are incorporated by references herein.

### BACKGROUND OF THE INVENTION

1. Field of the Invention

The present invention mainly relates to a turbine housing provided in a turbocharger for housing a turbine wheel.

2. Description of the Related Art

Various developments have been made for turbine housings to be used in turbochargers. A configuration of a typical turbine housing is as follows.

An wheel housing space for housing a turbine wheel is formed inside a turbine housing. Meanwhile, an annular flange, which is fastenable (connectable) to an annular counterpart flange on a bearing housing by use of a G-coupling, is formed on one end side in an axial direction of the wheel housing space of the turbine housing.

A gas introduction passage for introducing an exhaust gas is formed in the turbine housing on its side intersecting the axial direction. Meanwhile, a scroll passage in a scroll shape is formed around the wheel housing space inside the turbine housing. The scroll passage communicates with the wheel housing space as well as the gas introduction passage. The passage area of the scroll passage is gradually reduced from a roll-start side to a roll-end side. In addition, a gas discharge passage for discharging the exhaust gas is formed on the other end side in the axial direction of the turbine housing. The gas discharge passage communicates with the wheel housing space.

A housing tongue (a housing tongue portion) is formed in such a manner as to provide a partition between the gas introduction passage and the roll-end side of the scroll passage inside the turbine housing. The thickness of the housing tongue is gradually reduced toward its tip end side.

Accordingly, when the turbocharger including the typical turbine housing is activated, the exhaust gas introduced from the gas introduction passage flows into the wheel housing space via the scroll passage. Thus, the turbine wheel is caused to generate a rotational force by using pressure energy of the exhaust gas, and to rotate a compressor wheel provided coaxially and integrally with the turbine wheel. This makes it possible to supercharge (compress) the air to be supplied to an engine. Here, the exhaust gas having flowed into the wheel housing space is discharged from the gas discharge passage to the outside of the turbine housing.

Japanese Patent Application Laid-Open Publications Nos. 2010-144664 and Hei 7-49036 disclose the related art to the present invention.

### SUMMARY OF THE INVENTION

In the meantime, when the turbocharger is in operation, two wall surfaces (a wall surface on the gas introduction passage side and a wall surface on the scroll passage side) of the housing tongue are exposed to the high-temperature exhaust gas. As a consequence, the housing tongue is subjected to a large heat stress and is prone to a crack. Meanwhile, the flange is firmly fastened to the counterpart flange on the bearing housing by using the G-coupling. Accordingly, there may be a case where a base end portion of the flange is locally subjected to a high stress leading to cause a crack. Moreover, the housing tongue is located in the vicinity of the flange, and the crack caused in the housing tongue tends to develop into the flange side (radially outside). For this reason, if the crack caused in the housing tongue cannot be prevented from developing into the flange side, the crack caused in the housing tongue and the crack caused in the flange may be joined to each other and degrade durability of the turbine housing, depending on the operational status of the turbocharger. In other words, an effective measure for improving the durability of the turbine housing is to control the crack caused in the housing tongue so as to avoid its development into the flange side.

An object of the present invention is to provide a turbine housing and the like capable of improving its durability.

A first aspect of the present invention is a turbine housing of a turbocharger to be attached to a bearing housing thereof. Its gist is as follows. The turbine housing includes: an wheel housing unit configured to house a turbine wheel; a flange including an opening to allow insertion of the turbine wheel into the wheel housing unit; and a scroll passage formed along an outer periphery of the wheel housing unit, and provided with a roll-start portion communicating with a gas introduction passage for introducing a gas into the wheel housing unit, and a roll-end portion communicating with the wheel housing unit, wherein the scroll passage includes a housing tongue formed along the outer periphery of the wheel housing unit in such a manner as to provide a partition between the roll-end portion and the gas introduction passage, the housing tongue has a thickness which is gradually reduced toward its tip end side, and includes a groove portion formed in a wall surface on the scroll passage side and extending from the tip end side in an extending direction of the scroll passage, and the groove portion is located at a position close to an edge portion of the flange.

Here, the “tip end side of the housing tongue” means not only the tip end of the housing tongue but also a position close to the tip end of the housing tongue.

A second aspect of the present invention is a turbocharger configured to supercharge air to be supplied to an engine side by using energy of a gas from the engine. Its gist is that the turbocharger includes the turbine housing of the first aspect.

The present invention can prevent a crack that is caused in the vicinity of the groove portion of the housing tongue from developing into the flange side. Accordingly, the crack caused in the housing tongue is not joined to a crack caused in the flange. Thus, it is possible to provide the turbine housing capable of improving its durability.

### BRIEF DESCRIPTION OF THE DRAWINGS

FIG. 1A is a cross-sectional view of part of a turbocharger according to an embodiment of the present invention taken along the IA-IA line in FIG. 2, and FIG. 1B is an enlarged view of a portion indicated with an arrow 1B in FIG. 1A.

FIG. 2 is a cross-sectional view of the part of the turbocharger taken along the II-II line in FIG. 5.

FIG. 3 is a right side view of a turbine housing according to the embodiment of the present invention.

FIG. 4 is a left side view of the turbine housing according to the embodiment of the present invention.

FIG. 5 is a front sectional view of the part of the turbocharger according to the embodiment of the present invention.

### DESCRIPTION OF THE PREFERRED EMBODIMENTS

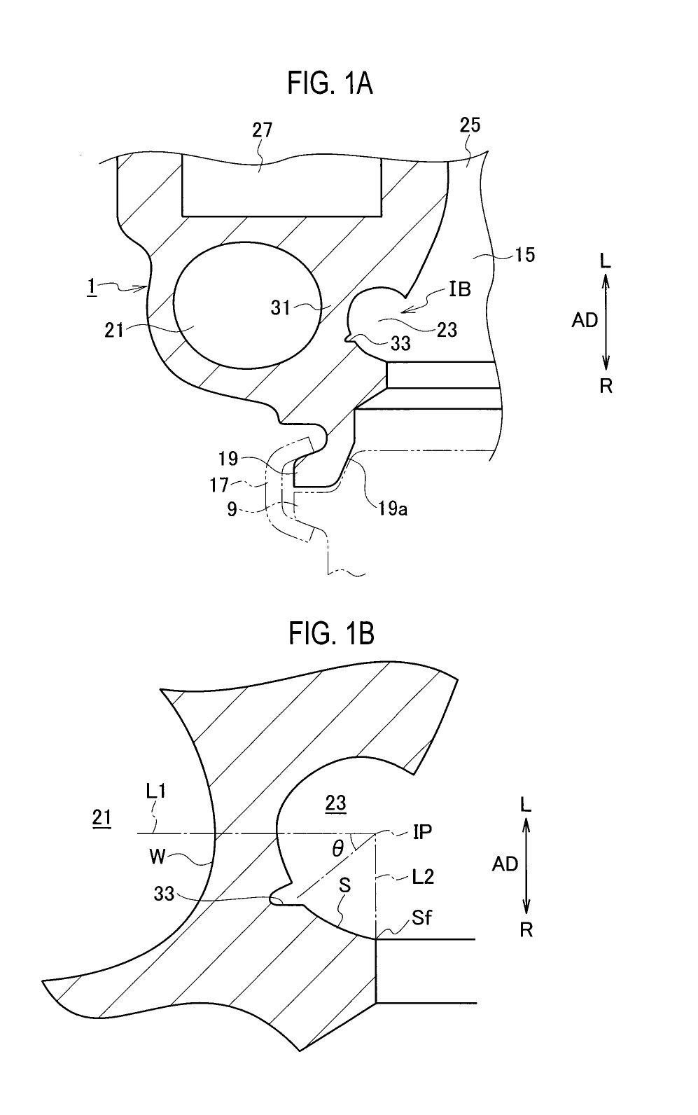

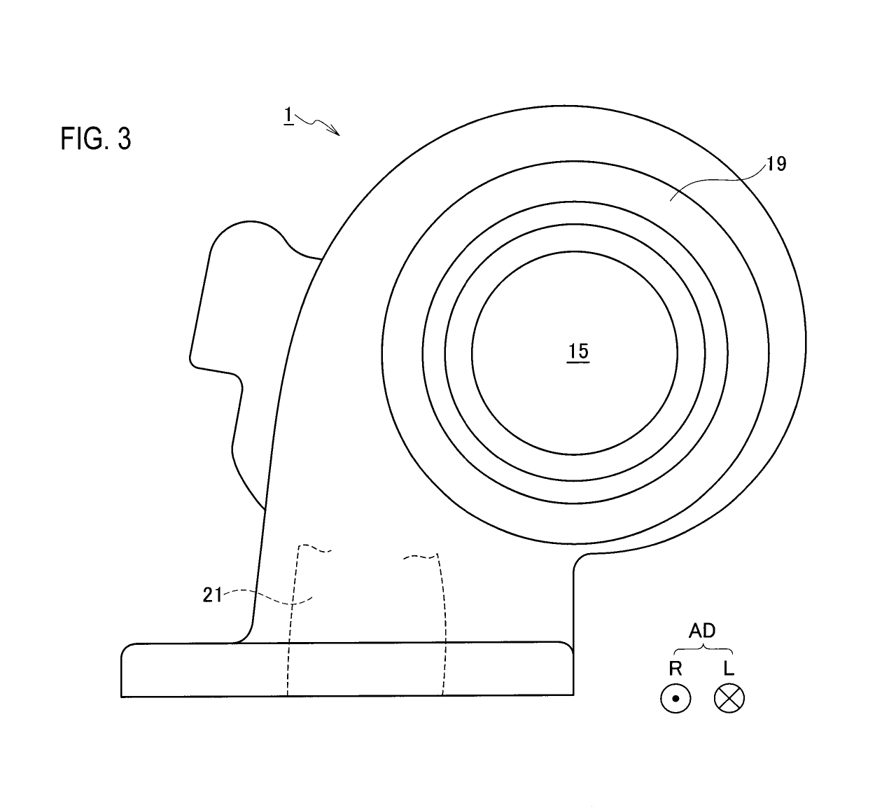

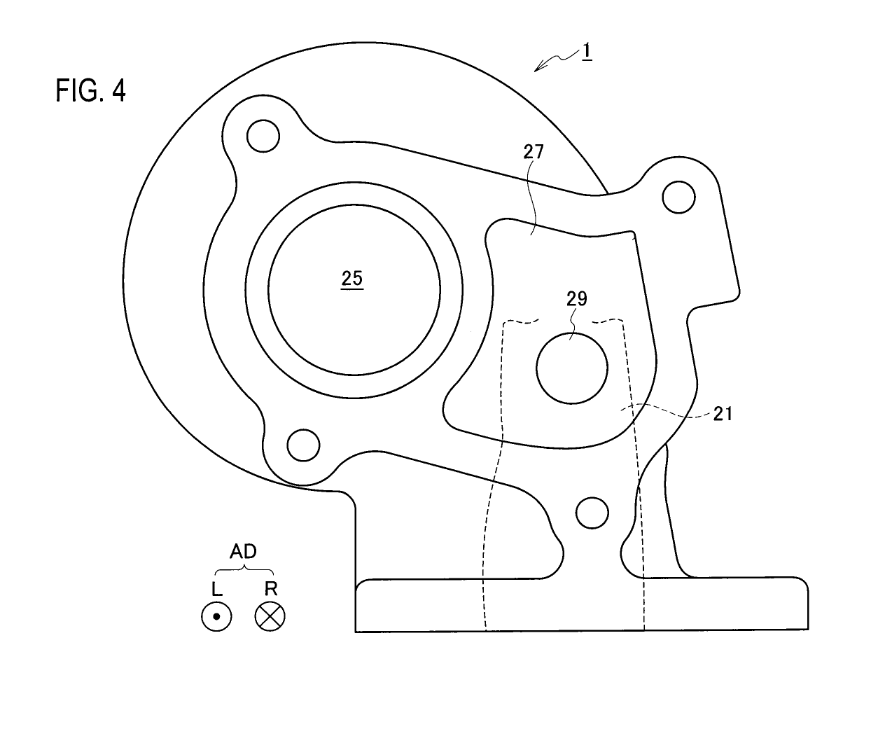

An embodiment of the present invention will be described with reference to FIG. 1A to FIG. 5. As shown in the drawings, “R” indicates a right direction while “L” indicates a left direction.

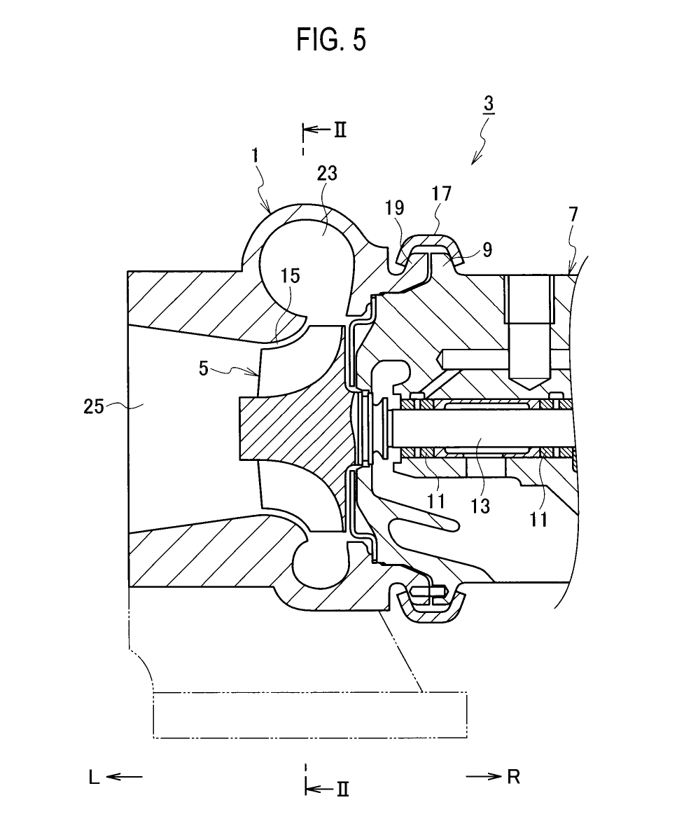

As shown in FIG. 5, a turbine housing (a housing body) 1 according to an embodiment of the present invention is used in a turbocharger 3 configured to supercharge (compress) air to be supplied to an engine (not shown) by using energy of an exhaust gas (an example of a gas) from the engine. The turbine housing 1 is designed to house a turbine wheel (turbine impeller) 5 of the turbocharger 3. Meanwhile, the turbine housing 1 can be attached to a bearing housing 7 of the turbocharger 3.

Here, an annular flange (a counterpart flange) 9 is formed at a left end portion of the bearing housing 7. Multiple (only one of which is illustrated) bearings 11 are provided inside the bearing housing 7. In addition, a rotor shaft (a turbine shaft) 13 extending in a right-left direction is rotatably provided to the multiple bearings 11. The above-mentioned turbine wheel 5 is formed integrally with a left end portion of the rotor shaft 13. Meanwhile, a compressor wheel (not shown) is integrally provided to a right end portion of the rotor shaft 13. In other words, the compressor wheel is provided coaxially and integrally with the turbine wheel 5 via the rotor shaft 13. A compressor housing (not shown) to house the compressor wheel (compressor impeller) is provided on the right side of the bearing housing 7.

Next, a specific configuration of the turbine housing 1 according to the embodiment of the present invention will be described.

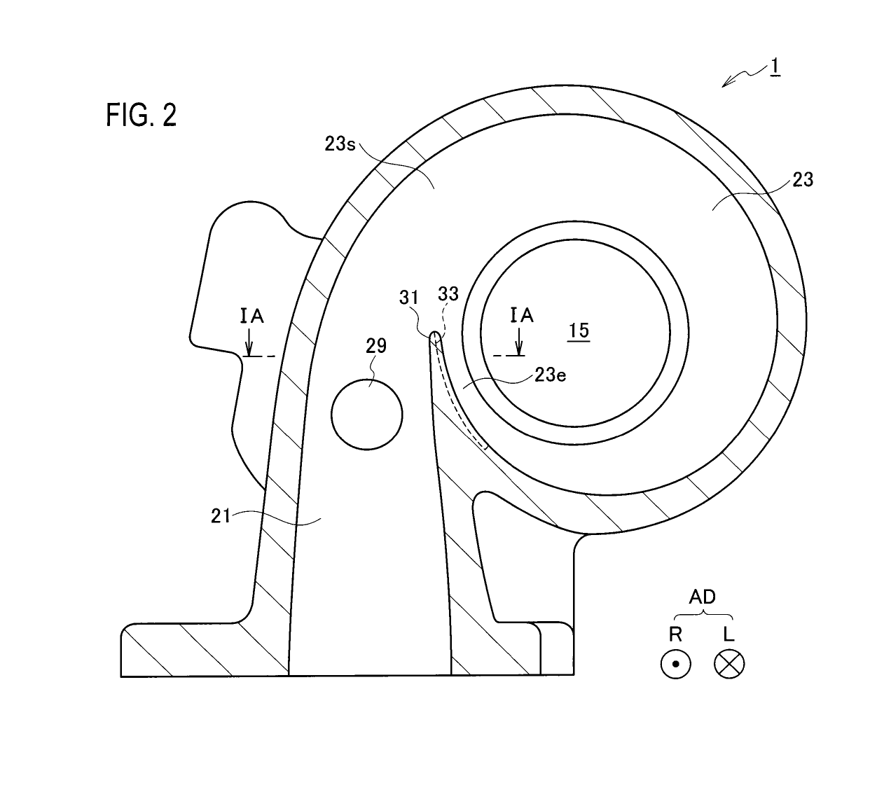

As shown in FIG. 2 to FIG. 4, an wheel housing space (an wheel housing unit) 15 for housing the turbine wheel 5 is formed inside the turbine housing 1. Meanwhile, an annular flange 19, which is fastenable (connectable) to the annular flange 9 on the bearing housing 7 by using a G-coupling (an example of a coupling) 17, is formed on one end side (a right end side) in an axial direction AD of the wheel housing space 15 of the turbine housing 1. The flange 19 includes an opening 19a for allowing insertion of the turbine wheel 5 into the wheel housing space 15. The opening 19a has a diameter equal to or greater than a diameter of the turbine wheel 5, and communicates with the wheel housing space 15. Here, as shown in FIG. 1A, the opening 19a may be formed into a tapered shape in such a way that the left end portion of the bearing housing 7 is fitted into the inside of the opening 19a.

A gas introduction passage (a gas introduction port) 21 for introducing the exhaust gas is formed in the turbine housing 1 on its side intersecting the axial direction AD of the wheel housing space 15. The gas introduction passage 21 is connectable to an exhaust manifold (not shown) of the engine. Meanwhile, a scroll passage 23 in a scroll shape is formed on the radially outside of the wheel housing space 15 provided inside the turbine housing 1. In other words, the scroll passage 23 is formed along the outer periphery of the wheel housing space 15. The scroll passage 23 causes the wheel housing space 15 and the gas introduction passage 21 to communicate with each other. The passage area of the scroll passage 23 is gradually reduced from a roll-start side (a roll-start portion) 23s that communicates with the gas introduction passage 21 to a roll-end side (a roll-end portion) 23e that communicates with the wheel housing space 15.

A gas discharge passage (a gas discharge port) 25 for discharging the exhaust gas is formed on the other end side (a left end side) in the axial direction AD of the wheel housing space 15 of the turbine housing 1. The gas discharge passage 25 communicates with the wheel housing space 15. In addition, a gas discharge passage (a gas discharge port) 27 for discharging the exhaust gas is formed on the radially outside of the gas discharge passage 25 in the turbine housing 1. The gas discharge passage 25 and the gas discharge passage 27 are connectable via a connection pipe (not shown) to a catalyst (not shown) which cleans up the exhaust gas. Moreover, a bypass passage (a bypass hole) 29 is formed on the radially outside of the wheel housing space 15 that is provided inside the turbine housing 1. The bypass passage 29 allows the exhaust gas introduced from the gas introduction passage 21 to reach the gas discharge passage 27 side (to an outlet side of the turbine housing 1) by bypassing the scroll passage. An opening of the bypass passage 29 is made openable and closable by actions of a waste gate valve (not shown).

As shown in FIG. 2, a housing tongue (a housing tongue portion) 31 is formed in such a manner as to provide a partition between the gas introduction passage 21 and the roll-end side 23e of the scroll passage 23 inside the turbine housing 1. In other words, the housing tongue 31 is formed along the outer periphery of the wheel housing space 15. The housing tongue 31 also includes a wall surface W on the gas introduction passage 21 side and a wall surface S on the scroll passage 23 side. The thickness of the housing tongue 31 is gradually reduced toward its tip end side.

As shown in FIG. 1A and FIG. 2, a groove portion (a notch) 33 is formed in the wall surface S on the scroll passage 23 side of the housing tongue 31. The groove portion 33 is located at a position close to an edge portion Sf on the flange 19 side. The groove portion 33 extends from a tip end side of the housing tongue 31 along an extending direction of the scroll passage 23. Meanwhile, in a cross section intersecting the housing tongue 31 and being orthogonal to the extending direction of the scroll passage 23, a curvature radius of the deepest part of the groove portion 33 is made smaller than a minimum curvature radius of the wall surface S on the scroll passage 23 side of the housing tongue 31. Here, multiple groove portions 33 may be provided in such a way that the multiple groove portions 33 extend from the tip end of the housing tongue 31 along the scroll passage 23.

Moreover, as shown in FIG. 1B, in a cross section along the axial direction AD of the wheel housing space 15 (in other words, the cross section intersecting the housing tongue 31 and being orthogonal to the extending direction of the scroll passage 23), the groove portion 33 is located at an angle from 20 to 80 degrees or more preferably from 40 to 60 degrees to a first virtual reference line L1 around an intersection point IP. Here, the first virtual reference line L1 means a virtual line which intersects the housing tongue 31 and, in the cross section orthogonal to the extending direction of the scroll passage 23, passes through the thinnest part of the housing tongue 31 and is orthogonal to the axial direction AD of the wheel housing space 15 (in other words, the extending direction of the scroll passage 23). In the meantime, a second virtual reference line L2 means a virtual line which intersects the housing tongue 31 and, in the cross section orthogonal to the extending direction of the scroll passage 23, passes through the edge portion Sf on the flange 19 side of the wall surface S on the scroll passage 23 side of the housing tongue 31 and is parallel to the axial direction AD of the wheel housing space 15 (in other words, orthogonal to the extending direction of the scroll passage 23). Here, the reason for setting an angular position θ of the groove portion 33 equal to or above 20 degrees is that it is difficult to sufficiently prevent a crack caused in the vicinity of the groove portion 33 of the housing tongue 31 from developing into the flange 19 side (radially outside) if the angle is below 20 degrees. On the other hand, the reason for setting the angular position θ of the groove portion 33 equal to or below 80 degrees is that it is difficult to prevent induction of a crack on the flange 19 side if the angle exceeds 80 degrees.

Next, a description will be given of the operation and effect of the embodiment of the present invention.

When the turbocharger 3 including the turbine housing 1 is activated, the exhaust gas introduced from the gas introduction passage 21 flows into the wheel housing space 15 via the scroll passage 23. Thus, the turbine wheel 5 is caused to generate a rotational force by using pressure energy of the exhaust gas, thereby rotating the compressor wheel. This makes it possible to compress the air that is taken into the compressor housing 1 and to discharge the compressed air from the compressor housing, and to supercharge the air to be supplied to the engine. Meanwhile, the exhaust gas having flowed into the wheel housing space 15 is discharged from the gas discharge passage 25 to the outside of the turbine housing 1.

When a pressure on an outlet side of the compressor wheel reaches a predetermined pressure while the supercharger 3 is in operation, the opening of the bypass passage 29 is opened by an action of the waste gate valve. Thus, an excessive rise in boost pressure is suppressed by allowing the exhaust gas flowing from the gas introduction passage 21 into the turbine housing 1 to reach the gas discharge passage 27 side by bypassing the scroll passage. Meanwhile, if the pressure on the outlet side of the compressor wheel falls below the predetermined pressure after the opening of the bypass passage 29 is opened, the opening of the bypass passage 29 is closed by an action of the waste gate valve.

Here, the groove portion 33 is formed in the wall surface S on the scroll passage 23 side of the housing tongue 31 and is located at the position close to the edge portion Sf on the flange 19 side. Since the groove portion 33 extends from the tip end of the housing tongue 31 along the scroll passage 23, it is possible to concentrate a heat stress that occurs in the housing tongue 31 when the turbocharger 3 is in operation on a section in the vicinity of the groove portion 33. In particular, the curvature radius of the deepest part of the groove portion 33 is made smaller than the minimum curvature radius of the wall surface S on the scroll passage 23 side of the housing tongue 31. Thus, the heat stress can be more efficiently concentrated on the section in the vicinity of the groove portion 33. This makes it possible to suppress occurrence of cracks at regions other than the section in the vicinity of the groove portion 33 of the housing tongue 31, and to sufficiently prevent a crack caused in the vicinity of the groove potion 33 of the housing tongue 31 from developing into the flange 19 side (radially outside).

Accordingly, the embodiment of the present invention can extend a product life of the turbine housing 1 while preventing a crack caused in the housing tongue 31 from being joined to a crack caused in the flange 19, thereby improving durability of the turbine housing 1 to a high level.

Note that the present invention is not limited to the above description of the embodiment but can be realized in various other modes by employing appropriate modifications. It is to be also understood that the scope of rights encompassed by the present invention shall not be limited to such embodiments.

1. A turbine housing of a turbocharger to be attached to a bearing housing thereof, comprises:
an wheel housing unit configured to house a turbine wheel;
a flange including an opening to allow insertion of the turbine wheel into the wheel housing unit; and
a scroll passage formed along an outer periphery of the wheel housing unit, and provided with a roll-start portion communicating with a gas introduction passage for introducing a gas into the wheel housing unit, and a roll-end portion communicating with the wheel housing unit, wherein
the scroll passage includes a housing tongue formed along the outer periphery of the wheel housing unit in such a manner as to provide a partition between the roll-end portion and the gas introduction passage,
the housing tongue has a thickness which is gradually reduced toward its tip end side, and includes a groove portion formed in a wall surface on the scroll passage side and extending from the tip end side in an extending direction of the scroll passage, and
the groove portion is located at a position close to an edge portion of the flange.

2. The turbine housing according to claim 1, wherein
in a cross section intersecting the housing tongue and being orthogonal to the extending direction of the scroll passage, a curvature radius of the deepest part of the groove portion is smaller than a minimum curvature radius of the wall surface on the scroll passage side of the housing tongue.

3. The turbine housing according to claim 1, wherein
in a cross section intersecting the housing tongue and being orthogonal to the extending direction of the scroll passage, and on the assumption of: a first virtual reference line passing through the thinnest part of the housing tongue and being orthogonal to the extending direction of the scroll passage; a second virtual reference line passing through the edge portion on the flange side of the wall surface on the scroll passage side of the housing tongue and being orthogonal to the extending direction of the scroll passage; and an intersection point of the first virtual reference line and the second virtual reference line, the groove portion is located at an angle of 20 to 80 degrees to the first virtual reference line around the intersection point.

4. The turbine housing according to claim 2, wherein
in a cross section intersecting the housing tongue and being orthogonal to the extending direction of the scroll passage, and on the assumption of: a first virtual reference line passing through the thinnest part of the housing tongue and being orthogonal to the extending direction of the scroll passage; a second virtual reference line passing through the edge portion on the flange side of the wall surface on the scroll passage side of the housing tongue and being orthogonal to the extending direction of the scroll passage; and an intersection point of the first virtual reference line and the second virtual reference line, the groove portion is located at an angle of 20 to 80 degrees to the first virtual reference line around the intersection point.

5. A turbocharger configured to supercharge air to be supplied to an engine side by using energy of a gas from the engine, comprises the turbine housing according to claim 1.
